(19) United States
(12) Patent Application Publication
(10) Pub. No.: US 2025/0207962 A1
(43) Pub. Date: Jun. 26, 2025

(54) METHOD FOR OPERATING A CORIOLIS MASS FLOWMETER AND CORRESPONDING CORIOLIS MASS FLOWMETER

(71) Applicant: KROHNE Messtechnik GmbH, Duisburg (DE)

(72) Inventors: Johannes KUNZE, Muelheim an der Ruhr (DE); Alexander ERKELENZ, Duisburg (DE); Ralf STORM, Essen (DE); Volker STEGEMANN, Bochum (DE)

(73) Assignee: KROHNE Messtechnik GmbH, Duisburg (DE)

(21) Appl. No.: 18/989,836

(22) Filed: Dec. 20, 2024

(30) Foreign Application Priority Data
Dec. 22, 2023 (DE) 10 2023 136 442.1

(51) Int. Cl. G01F 1/84

(52) U.S. Cl. CPC G01F 1/8436; G01F 1/8422; G01F 1/8427; G01F 1/8431

(57) ABSTRACT

A method for operating a Coriolis mass flow meter that has at least one measuring tube. A medium can flow through the measuring tube and an oscillation generator excites the measuring tube to oscillate. A first and second oscillation sensors capture the oscillations of the measuring tube on the inlet side and on the outlet side and provide them as a first oscillation signal and as a second oscillation signal. In order to be able to continue the measurement operating position of the first multiplexer and the second multiplexer at the same time as the test for the simultaneous measurement operating position, the first oscillation signal is phase-shifted by a phase shift and the phase-shifted first oscillation signal is transmitted at least indirectly to a control and evaluation unit.

### BACKGROUND OF THE INVENTION

This nonprovisional application claims priority under 35 U.S.C. § 119(a) to German Patent Application No. 10 2023 136 442.1, which was filed in Germany on Dec. 22, 2023, and which is herein incorporated by reference.

### Field of the Invention

The invention relates to a method for operating a Coriolis mass flow meter, wherein the Coriolis mass flow meter has at least one measuring tube, at least one oscillation generator, at least two oscillation sensors, at least one first and one second multiplexer, each having a plurality of operating positions, and at least one control and evaluation unit, wherein a medium can flow through the measuring tube, wherein the oscillation generator excites the measuring tube to oscillate, wherein the first and second oscillation sensors capture the oscillations of the measuring tube on the inlet side and on the outlet side and provide them as a first oscillation signal and as a second oscillation signal, wherein the first oscillation signal is transmitted via the first multiplexer in a measurement operating position of the first multiplexer at least indirectly to the control and evaluation unit, and wherein the second oscillation signal is transmitted via the second multiplexer in a measurement operating position of the second multiplexer at least indirectly to the control and evaluation unit, and wherein the control and evaluation unit determines an oscillation signal phase difference between the transmitted first oscillation signal and the transmitted second oscillation signal and determines a mass flow rate from the oscillation signal phase difference. In addition, the invention also relates to a corresponding Coriolis mass flowmeter which carries out the method described above during operation.

### Description of the Background Art

Coriolis mass flow meters have been known in the prior art for decades. The mass flow of a medium through the measuring tube is determined by using the Coriolis effect. For this purpose, the measuring tube through which the medium flows is set into oscillation by at least one oscillation generator, as described above. The oscillation of the measuring tube, viewed in the direction of flow, is captured on the inlet and outlet side by oscillation sensors that are operatively connected to the measuring tube and provided as oscillation signals. Without flow, the oscillations captured and the oscillation signals provided by the two oscillation sensors are theoretically in phase in the ideal case. With a mass flow, there is a differently directed Coriolis force on the inlet and outlet sides, which leads to a minimal phase shift between the deflections and thus also between the two oscillations captured by the oscillation sensors. Therefore, in this case there is also an oscillation signal phase difference between the vibration signals of the oscillation sensors. The vibration signal phase difference is very small, typically in the range of arc minutes, but it nevertheless contains information about the mass flow through the measuring tube. The phase shift is proportional to the mass flow within the measuring tube. It is therefore evaluated and a mass flow rate is determined from it.

The use of a multiplexer in each measurement path, running from each of the two oscillation sensors to the control and measurement unit, can have very different reasons. For example, it may be desirable to use the measurement channels not only to capture the oscillation signals supplied by the oscillation sensors, but also to capture other measured variables that are fed into the connected measurement channel by the multiplexer. Another reason may lie in a switchover of the measuring channels to be implemented, in which the first oscillation sensor is switched to the second measuring channel and the second oscillation sensor to the first measuring channel, for example to be able to average out different transit times in the measuring channels.

When it is said that the first oscillation signal and the second oscillation signal are transmitted at least indirectly via the multiplexers to the control and evaluation unit, this means that an original oscillation signal, which thus originates directly from the oscillation sensors, can undergo quite extensive signal processing on its way to the control and evaluation unit, for example analog amplification, impedance conversion, analog/digital conversion, low-pass filtering, phase detection, etc. However, this is not of interest in detail, it is only important that a signal, which in any case is based on an oscillation originally captured by the oscillation sensor, is transmitted to the control and evaluation unit; once there, it is referred to as a transmitted oscillation signal.

The multiplexers are accordingly arranged in the beginning area of the measuring chain—usually in the signal path directly behind the oscillation sensors—i.e. in the area of the measuring section that works with analog signals. The multiplexers are thus usually also analog multiplexers. The multiplexers have several operating positions that define which input of the multiplexer is switched to an output of the multiplexer. Particularly with mechanically implemented analog multiplexers, which are preferably used with gold-plated switching contacts, especially in measurement technology, in order to minimize resistances in the measurement paths caused by the multiplexers, it can happen that a change between different operating positions is not carried out successfully.

It is therefore known in the conventional art to check whether the two multiplexers are together in the measurement operating position, i.e. whether the first multiplexer passes through the oscillation signal of the first oscillation sensor and the second multiplexer passes through the oscillation signal of the second oscillation sensor. For this purpose, a harmonic test signal is switched to the measurement channel input to which the oscillation sensors are connected instead of the oscillation sensor signals, so that the control and evaluation unit can detect whether this test signal is received on both measurement channels, which requires the measurement operating position of both multiplexers.

The disadvantage of this procedure is that the measuring operation of the Coriolis mass flow meter must be suspended while the correct operating position of the multiplexers is being checked, which naturally represents a restriction of the measuring operation.

### SUMMARY OF THE INVENTION

It is therefore an object of the present invention to provide a method for checking whether or not the multiplexers are simultaneously in the measurement operating position without interrupting the measurement operation.

The object derived above is achieved in the method described at the beginning for operating a Coriolis mass flowmeter, namely in that the first oscillation signal is phase-shifted by a phase shift and the phase-shifted first oscillation signal is transmitted at least indirectly to the control and evaluation unit via the first multiplexer and, taking the transmitted oscillation signal shifted by the phase shift into account, the control and evaluation unit determines the mass flow rate, and that by comparing the oscillation signal phase difference with the phase shift of the first oscillation signal, the control and evaluation unit detects whether an operating position of the first multiplexer and an operating position of the second multiplexer are simultaneously the measurement operating position.

With the described procedure, it is possible to easily detect whether the first multiplexer and the second multiplexer are in the measurement operating position at the same time or not, without interrupting the measurement operating position of the Coriolis mass flowmeter.

The phase shift by which the first oscillation signal is phase shifted can be considerably greater than a maximum measurement phase difference that can be caused by a mass flow rate within the measuring region. Preferably, the phase shift is selected to be at least a factor of ten, more preferably at least a factor of one hundred greater than the maximum measurement phase difference. The measurement phase differences are usually only in the range of a fraction of a degree. If operating frequencies of the Coriolis mass flow meter in the range of a kHz are assumed, then it becomes clear that a typical measurement phase difference is equivalent to a detection of time differences in the range of a few microseconds (and also below this time domain).

The phase shift of the first oscillation signal can be 180°, which can be implemented relatively easily using an analog inverter circuit, for example. In a particularly preferred design of the method, the 180° phase shift of the first oscillation signal is implemented by mounting or connecting the first and second oscillation sensors in such a way that the oscillation signals caused by one and the same oscillation of the measuring tube (i.e. at zero flow) are 180° out of phase. This can be achieved, for example, by attaching coils as oscillation sensors to the measuring tube with the opposite orientation, so that one and the same movement of the measuring tube generates exactly opposite oscillation signals at correspondingly identical terminals of the oscillation sensors, or by attaching coils as oscillation sensors to the measuring tube with the same orientation, but connecting the terminals of the first coil as the first oscillation sensor reversed to the terminals of the first multiplexer compared to the connection of the terminals of the second coil as the second oscillation sensor to the terminals of the second multiplexer. The advantage of the last two solution variations shown is that no additional circuitry is required.

When it is stated that the control and evaluation unit determines the mass flow rate taking into account the first oscillation signal shifted by the phase shift and transmitted, this may mean that the phase shift is subtracted from the oscillation signal phase difference or from a determined phase of the first transmitted oscillation signal, and the mass flow rate is determined using the oscillation signal phase difference corrected in this way.

The control and evaluation unit can detect the simultaneous measurement operating position of the first multiplexer and the second multiplexer when the oscillation signal phase difference—i.e. the uncorrected oscillation signal phase difference in which the phase shift of the first transmitted oscillation signal is still present—is within a tolerance band around the phase shift of the first oscillation signal. Preferably, the tolerance band has the width of the maximum measurement phase difference, as a variation of the phase shift in this range is possible solely by the measurement that continues to take place.

The control and evaluation unit can compare the detected operating positions of the first multiplexer and the second multiplexer—first multiplexer and second multiplexer simultaneously in measurement operating position or not—with predetermined target operating positions of the first multiplexer and the second multiplexer—target operating position of the first multiplexer and target operating position of the second multiplexer simultaneously in measurement operating position or not—and if the detected operating positions deviate from the target operating positions, the control and evaluation unit signals a deviation signal.

The deviation signal can be stored as information in a memory of the control and evaluation unit and/or the deviation signal is output with a bus message via a fieldbus interface of the Coriolis mass flowmeter and/or the deviation signal is output with a bus message via a diagnostic interface via which no measurement data is output and/or the deviation signal is output in coded form as a current value via a current interface of the Coriolis mass flowmeter.

The object is also achieved in the Coriolis mass flow meter described, in that the first oscillation signal can be phase-shifted by a phase shift and the phase-shifted first oscillation signal can be transmitted via the first multiplexer at least indirectly to the control and evaluation unit and the control and evaluation unit determines the mass flow rate taking into account the first oscillation signal shifted by the phase shift and transmitted and that the control and evaluation unit can detect by comparing the oscillation signal phase difference with the phase shift of the first oscillation signal, whether an operating position of the first multiplexer and an operating position of the second multiplexer are simultaneously the measurement operating position.

The Coriolis mass flow meter also carries out the various designs of the method described above with a correspondingly designed control and evaluation unit. Preferably, the Coriolis mass flow meter can be designed in such a way that the phase shift is 180° and is implemented by mounting or connecting the first oscillation sensor and the second oscillation sensor in such a way that the oscillation signals caused by one and the same oscillation of the measuring tube are 180° out of phase, in particular in that coils as oscillation sensors are attached to the measuring tube in an inverted orientation or in that coils as oscillation sensors are attached to the measuring tube in the same orientation, but the terminals of the first coil as the first oscillation sensor are connected to terminals of the first multiplexer in an inverted manner compared to the connection of the terminals of the second coil as the second oscillation sensor to the terminals of the second multiplexer.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows, a conventional method for operating a Coriolis mass flow meter and a corresponding Coriolis mass flow meter with the possibility of checking the operating position of multiplexers when the measuring operation is interrupted,

FIG. 2 schematically shows, a method for operating a Coriolis mass flowmeter and a corresponding Coriolis mass flowmeter with the possibility of checking the operating position of multiplexers while continuing measurement operation, and

FIG. 3 schematically shows, a method for operating a Coriolis mass flowmeter and a corresponding Coriolis mass flowmeter in which a phase shift of 180° is implemented very simply.

### DETAILED DESCRIPTION

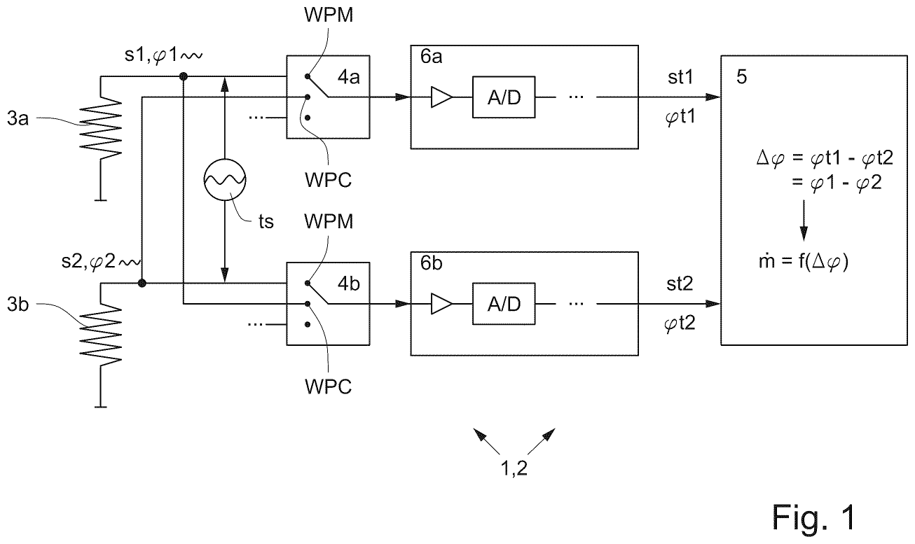

FIGS. 1 to 3 each illustrate methods 1 for operating a Coriolis mass flowmeter 2 and certain aspects of a Coriolis mass flowmeter 2 which are of interest for understanding the subject matter of the invention. The Coriolis mass flow meter 2 has as necessary for functioning at least one measuring tube and at least one oscillation generator, which excites the measuring tube to a harmonic oscillation, usually in the fundamental mode of the measuring tube; both elements are not shown for reasons of clarity. The Coriolis mass flow meters 2 considered here also have at least two oscillation sensors 3a, 3b, at least one first and one second multiplexer 4a, 4b, each with several operating positions WP, and at least one control and evaluation unit 5. The control and evaluation unit 5 can be for example, a processor, a computer, a programmable logic controller, etc.

During operation of the Coriolis mass flow meter 2, a medium flows through the measuring tube, wherein the first and second oscillation sensors 3a, 3b, shown here as coils, capture the oscillations of the measuring tube on the inlet and outlet sides and provide them as a first oscillation signal s1 and a second oscillation signal s2. The first oscillation signal s1 has a phase position φ1, the second oscillation signal s2 has a phase position φ2. Both numbers and letters are used as reference signs in the figures. The letters only have the character of reference signs, but they make it much easier to understand and establish the connection between the description and the drawing.

The first oscillation signal s1 is transmitted indirectly to the control and evaluation unit 5 via the first multiplexer 4a in a measurement operating position WPM of the first multiplexer 4a, and the second oscillation signal s2 is transmitted indirectly to the control and evaluation unit 5 via the second multiplexer 4b in a measurement operating position WPM of the second multiplexer 4b. The phrase “indirectly transmitted” takes into account that the first oscillation signal s1 and the second oscillation signal s2 provided by the oscillation sensors 3a, 3b can undergo further signal processing until the oscillation signals s1, s2 ultimately arrive at the control and evaluation unit 5. The first oscillation signal s1 and the second oscillation signal s2 may therefore undergo a conversion, but this is not the point here. Ultimately, the first oscillation signal s1 arrives at the control and evaluation unit 5 as the first transmitted oscillation signal st1 with the phase position φt1, and the second oscillation signal s2 ultimately arrives at the control and evaluation unit 5 as the second transmitted oscillation signal st2 with the phase position φt2. The control and evaluation unit 5 then determines an oscillation signal phase difference Δφ between the transmitted first oscillation signal st1 and the transmitted second oscillation signal st2, and a mass flow rate is finally determined from the oscillation signal phase difference Δφ, shown in the figures as an m-point, i.e. as a change in the mass flowing through the measuring tube over time.

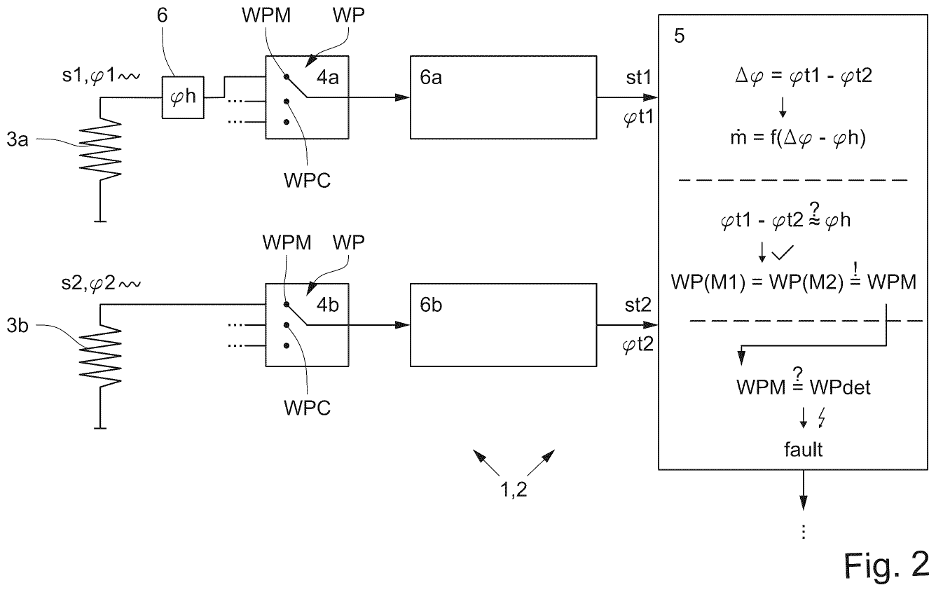

In FIG. 1, in connection with the control and evaluation unit 5, it is shown in idealized form that the phase difference Δφ between the phase shift φt1 of the first transmitted oscillation signal st1 and the phase shift φt2 of the second transmitted oscillation signal st2 is equal to the difference between the phase shifts φ1 of the first oscillation signal s1 and the phase shift φ2 of the second oscillation signal st2. In practice, this does not have to be the case—due to interference effects—but this is not important for the object of the method of interest here. In FIGS. 1 and 2, the signal processing that the captured first oscillation signal s1 and the captured second oscillation signal s2 pass through is shown schematically as measurement channels 6a, 6b.

The multiplexers 4a, 4b are designed as analog multiplexers. With such multiplexers, one possible error is that the switchover between different operating positions WP of the multiplexers is not carried out. As already mentioned in the general description section, the multiplexers 4a, 4b are used to switch different measuring signals to the measuring channels 6a, 6b. In the measurement operating position WPM, the first oscillation signal s1 is forwarded to the control and evaluation unit 5 via the first measurement channel 6a and the second oscillation signal s2 is also forwarded to the control and evaluation unit 5 via the second measurement channel 6b.

Another operating position WP of the multiplexers 4a, 4b is shown, which implements an alternating operating position WPC, in which the first oscillation signal s1 is switched to the second measuring channel 6b and the second oscillation signal s2 is switched to the first measuring channel 6a. This serves, for example, to eliminate transit time differences in the various measuring channels 6a, 6b, usually by calculation in the control and evaluation unit 5. Also shown is a further operating position WP of the multiplexers 4a, 4b, in which, for example, other measuring signals can be routed to the measuring channels 6a, 6b.

In FIG. 1, one conventional way of checking whether the multiplexers 4a, 4b are in their measurement operating position WPM is shown. It is therefore checked whether the two multiplexers 4a, 4b are together in the measurement operating position WPM, i.e. whether the first multiplexer 4a transmits the oscillation signal s1 of the first oscillation sensor 3a and whether the second multiplexer 4b transmits the oscillation signal s2 of the second oscillation sensor 3b to the control and evaluation unit 5. For this purpose, a harmonic test signal ts is switched to the input of the multiplexer 4a, 4b connected upstream of the respective measuring channel 6a, 6b instead of the oscillation signals s1, s2 of the oscillation sensors 3a, 3b, so that the control and evaluation unit 5 can detect whether this test signal ts is received on both measuring channels 6a, 6b. FIG. 1 does not show in detail that other circuitry measures may be required to implement decoupling of the oscillation sensors 3a, 3b from the inputs of the multiplexers 4a, 4b; however, this is not the point here. The disadvantage of this procedure is that the measuring operation of the Coriolis mass flow meter 2 must be suspended while the correct operating position WP of the multiplexers 4a, 4b is checked, which of course restricts the measuring operation.

In the example of the method 1 and the Coriolis mass flowmeter 2 according to FIG. 2, the procedure is different. The first oscillation signal s1 is phase-shifted by a phase shift oh by means of a phase shifter 6 and the phase-shifted first oscillation signal s1 is transmitted via the first multiplexer 4a—again at least indirectly—to the control and evaluation unit 5. The control and evaluation unit 5 determines the mass flow rate, taking into account—for example by subtracting out—the first oscillation signal st1 which is shifted by the phase shift φh and transmitted, thus fulfilling the primary task of the Coriolis mass flow meter 2. In the calculation shown in FIG. 2, it has again been assumed for the sake of simplicity that the phase positions φ1, φ2 of the oscillation signals s1, s2 (at least relative to each other) are ideally maintained in the transmitted oscillation signals st1, st2.

It is of interest here that the control and evaluation unit 5 detects whether an operating position WP of the first multiplexer 4a and an operating position WP of the second multiplexer 4b are simultaneously the measurement operating position WPM (WP(M1)=WP(M2)=WPM; in FIG. 2, M1, M2 stand for the first and second multiplexers 4a, 4b) by comparing the oscillation signal phase difference Δφ with the phase shift φh of the first oscillation signal s1. Compared to the prior art method 1 according to FIG. 1, however, this can be done in a clearly recognizable manner while simultaneously carrying out the flow measurement, which represents a significant improvement in operating behavior.

The phase shift φh, by which the first oscillation signal s1 is phase-shifted, is selected to be considerably larger than a maximum measurement phase difference that can be caused by a mass flow rate lying within the measuring region. The phase shift φh is selected here to be a factor of one hundred greater than the maximum measurement phase difference. More precisely, in the embodiment shown in FIG. 2, the phase shift φh of the first oscillation signal s1 is 180°, which is simply implemented using an analog inverter.

In the inventive example shown in FIG. 2, it is actually implemented that the simultaneous measurement operating position WPM of the first multiplexer 4a and the second multiplexer 4b is detected by the control and evaluation unit 5 when the oscillation signal phase difference Δφ is within a tolerance band around the phase shift φh of the first oscillation signal s1, wherein the tolerance band has the width of the maximum measurement phase shift. This ensures that phase deviations in the range of possible measurement phase deviations are tolerated.

It is also implemented in the method 1 and the Coriolis mass flow meter 2 according to FIG. 2 that the control and evaluation unit 5 compares the detected operating positions WP of the first multiplexer 4a and the second multiplexer 4b—first multiplexer 4a and second multiplexer 4b simultaneously in measurement operating position WPM or not—, with predetermined target operating positions WPdet of the first multiplexer 4a and the second multiplexer 4b—target operating position WPdet of the first multiplexer 4a and target operating position WPdet of the second multiplexer 4b simultaneously in measurement operating position WPM or not—and signals a deviation signal fault if the detected operating positions WP deviate from the target operating positions WPdet.

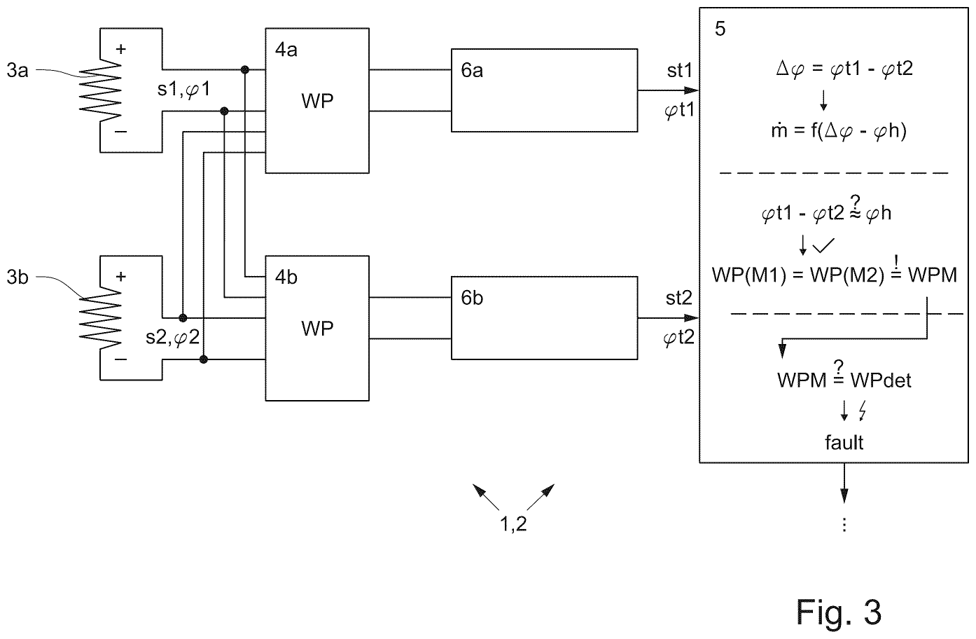

In the method 1 and the Coriolis mass flow meter 2 according to FIG. 3, a phase shift φh of 180° is implemented in a very simple way. As in the embodiment of FIG. 2, the oscillation sensors 3a, 3b are implemented as coils. Both terminals of the coils are routed via the multiplexers 4, which are designed as double multiplexers, so the oscillation signals here are differential signals; for the sake of clarity, the multiplexers are not shown as an internal circuit. The first oscillation sensor 3a and the second oscillation sensor 3b are mounted in such a way that the oscillation signals caused by one and the same oscillation of the measuring tube are phase-shifted by 180°. The coils are attached to the measuring tube with the opposite orientation, indicated by the different signs at the coil connections.

A comparable solution, can be implemented with coils as oscillation sensors 3a, 3b, which are attached to the measuring tube in the same orientation, wherein the terminals of the first coil as the first oscillation sensor 3a are connected reversed to the terminals of the first multiplexer 4a compared to the connection of the terminals of the second coil as the second oscillation sensor 3b to the terminals of the second multiplexer 4b.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to operate a Coriolis mass flow meter that comprises at least one measuring tube, at least one oscillation generator, at least two oscillation sensors, at least one first and one second multiplexer, each having a plurality of operating positions, and at least one control and evaluation unit, a medium is adapted to flow through the measuring tube, the method comprising;
exciting, via the oscillation generator, the measuring tube to oscillate;
capturing, via the first and second oscillation sensors, oscillations of the measuring tube on an inlet side and on an outlet side and provide them as a first oscillation signal and as a second oscillation signal;
transmitting the first oscillation signal at least indirectly to the control and evaluation unit via the first multiplexer in a measurement operating position of the first multiplexer;
transmitting the second oscillation signal via the second multiplexer in a measurement operating position of the second multiplexer at least indirectly to the control and evaluation unit;
determining, via the control and evaluation unit, an oscillation signal phase difference between the transmitted first oscillation signal and the transmitted second oscillation signal;
determining a mass flow rate from the oscillation signal phase difference;
phase-shifting the first oscillation signal by a phase shift;
transmitting the phase-shifted first oscillation signal at least indirectly to the control and evaluation unit via the first multiplexer;
determining a mass flow rate via the control and evaluation unit by taking the transmitted oscillation signal shifted by the phase shift into account; and
comparing the oscillation signal phase difference with the phase shift of the first oscillation signal, the control and evaluation unit detects whether an operating position of the first multiplexer and an operating position of the second multiplexer are substantially simultaneously a measurement operating position.

2. The method according to claim 1, wherein the phase shift by which the first oscillation signal is phase-shifted, is considerably greater than a maximum measuring phase difference which is caused by a mass flow rate within the measuring region, or wherein the phase shift is selected to be greater than the maximum measuring phase difference by at least a factor of ten or by at least a factor of one hundred.

3. The method according to claim 1, wherein the phase shift of the first oscillation signal is 180°, or wherein the phase shift is implemented by an analog inverter.

4. The method according to claim 3, wherein the 180° phase shift of the first oscillation signal is implemented in that the first oscillation sensor and the second oscillation sensor are mounted or connected such that the oscillation signals caused by one and the same oscillation of the measuring tube are phase-shifted by 180°, or wherein coils as oscillation sensors are attached to the measuring tube in reverse orientation, or wherein coils as oscillation sensors are attached to the measuring tube in a same orientation, but the terminals of the first coil as the first oscillation sensor are connected to terminals of the first multiplexer in a reversed manner compared to the connection of the terminals of the second coil as the second oscillation sensor to the terminals of the second multiplexer.

5. The method according to claim 1, wherein the substantially simultaneous measurement operating position of the first multiplexer and the second multiplexer is detected by the control and evaluation unit when the oscillation signal phase difference is within a tolerance band around the phase shift of the first oscillation signal, or wherein the tolerance band has the width of the maximum measurement phase shift.

6. The method according to claim 1, wherein the control and evaluation unit compares the detected operating positions of the first multiplexer and the second multiplexer to determine:
whether the first multiplexer and second multiplexer are substantially simultaneously in a measurement operating position or not; and
whether, with predetermined target operating positions of the first multiplexer and the second multiplexer, a target operating position of the first multiplexer and a target operating position of the second multiplexer simultaneously in measuring operating position or not; and
wherein the control and evaluation unit signals a deviation signal if the detected operating positions deviate from the target operating positions.

7. The method according to claim 6, wherein the deviation signal is stored as information in a memory of the control and evaluation unit, and/or wherein the deviation signal is output with a bus message via a field bus interface of the Coriolis mass flowmeter, and/or wherein the deviation signal is output with a bus message via a diagnostic interface, via which no measurement data is output, of the Coriolis mass flowmeter, and/or wherein the deviation signal is output in coded form as a current value via a current interface of the Coriolis mass flowmeter.

8. A Coriolis mass flow meter comprising:
at least one measuring tube;
at least one oscillation generator;
at least two oscillation sensors; and
at least one control and evaluation unit,
wherein a medium is adapted to flow through the measuring tube,
wherein the oscillation generator excites the measuring tube to oscillate,
wherein the first and second oscillation sensors capture the oscillations of the measuring tube on an inlet side and on an outlet side and provide them as a first oscillation signal and as a second oscillation signal,
wherein the first oscillation signal is transmitted at least indirectly to the control and evaluation unit via the first multiplexer in a measurement operating position of the first multiplexer,
wherein the second oscillation signal is transmitted via the second multiplexer in a measurement operating position of the second multiplexer at least indirectly to the control and evaluation unit,
wherein the control and evaluation unit determines an oscillation signal phase difference between the transmitted first oscillation signal and the transmitted second oscillation signal and determines a mass flow rate from the oscillation signal phase difference,
wherein the first oscillation signal is phase-shifted by a phase shift and the phase-shifted first oscillation signal is transmitted at least indirectly to the control and evaluation unit via the first multiplexer,
wherein, by taking the transmitted oscillation signal shifted by the phase shift into account, the control and evaluation unit determines the mass flow rate, and
wherein, by comparing the oscillation signal phase difference with the phase shift of the first oscillation signal, the control and evaluation unit detects whether an operating position of the first multiplexer and an operating position of the second multiplexer are substantially simultaneously the measurement operating position.

9. The coriolis mass flowmeter according to claim 8, wherein the control and evaluation unit is designed such that, during operation of the Coriolis mass flowmeter, it carries out a method comprising:
determining, via the control and evaluation unit, an oscillation signal phase difference between the transmitted first oscillation signal and the transmitted second oscillation signal;
determining a mass flow rate from the oscillation signal phase difference;
phase-shifting the first oscillation signal by a phase shift;
transmitting the phase-shifted first oscillation signal at least indirectly to the control and evaluation unit via the first multiplexer;
determining a mass flow rate via the control and evaluation unit by taking the transmitted oscillation signal shifted by the phase shift into account; and
comparing the oscillation signal phase difference with the phase shift of the first oscillation signal, the control and evaluation unit detects whether an operating position of the first multiplexer and an operating position of the second multiplexer are substantially simultaneously a measurement operating position.

10. The coriolis mass flowmeter according to claim 8, wherein the phase shift is generated with a phase shifter or wherein the phase shift is 180° and the phase shifter is an analog inverter.

11. The coriolis mass flowmeter according to claim 8, wherein the phase shift is 180° and is implemented in that the first oscillation sensor and the second oscillation sensor are mounted or connected such that the oscillation signals caused by one and the same oscillation of the measuring tube are 180° out of phase, or wherein the coils as oscillation sensors are mounted on the measuring tube in an inverted orientation or wherein the coils as oscillation sensors are mounted on the measuring tube in the same orientation, but the terminals of the first coil as the first oscillation sensor are connected to terminals of the first multiplexer in an inverted manner compared to the connection of the terminals of the second coil as the second oscillation sensor to the terminals of the second multiplexer.
